(19) United States
(12) Patent Application Publication
(10) Pub. No.: US 2013/0275084 A1
(43) Pub. Date: Oct. 17, 2013

(54) ESTIMATING A METRIC RELATED TO A SERVICE DEMAND USING A DEFINED FRAMEWORK

(71) Applicants: Cullen E. Bash, Los Gatos, CA (US); Yuan Chen, Sunnyvale, CA (US); Kiara Groves Corrigan, Burlingame, CA (US); Daniel Juergen Gmach, Palo Alto, CA (US); Dejan S. Milojicic, Palo Alto, CA (US); Amip J. Shah, Santa Clara, CA (US)

(72) Inventors: Cullen E. Bash, Los Gatos, CA (US); Yuan Chen, Sunnyvale, CA (US); Kiara Groves Corrigan, Burlingame, CA (US); Daniel Juergen Gmach, Palo Alto, CA (US); Dejan S. Milojicic, Palo Alto, CA (US); Amip J. Shah, Santa Clara, CA (US)

(21) Appl. No.: 13/445,691

(22) Filed: Apr. 12, 2012

(51) Int. Cl. G06F 19/00

(52) U.S. Cl. 702/179

(57) ABSTRACT

In a method for estimating a metric related to a service demand, a framework to be used in evaluating a services ecosystem or a services infrastructure is defined. The framework comprises a matrix of elements, in which the elements comprise a plurality of services and a plurality of services components that are usable in delivering at least one of the plurality of services. In addition, dependencies between the matrix elements are determined using initialization data and the metric related to the service demand is estimated through use of the framework.

### CROSS-REFERENCE TO RELATED APPLICATIONS

This application contains some common subject matter with co-pending U.S. patent application Ser. No. 12/824,699, filed on Jun. 28, 2010, titled “Determining Environmental Impact”; PCT Application Serial No. PCT/US2011/56490, filed on Oct. 15, 2011, titled “Service Sustainability Systems and Methods”; PCT Application Serial No. PCT/US2011/56491, filed on Oct. 15, 2011, titled “Quantifying Power Usage for a Service”; U.S. patent application Ser. No. 13/015,501, filed on Jan. 27, 2011, titled “Determining an Entity's Share of Economic Environmental Burden”, the disclosures of which are hereby incorporated by reference in their entireties.

### BACKGROUND

There has been increasing interest by service providers, such as, information technology service providers, to evaluate the impacts of their activities. Examples of these impacts include carbon emissions, recycling efforts, energy consumption, and water use. In addition, concern over sustainability is also increasing for service providers as a result of increasing demand for services, rising energy costs, regulatory requirements, and social concerns over greenhouse gas emissions.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a metric estimating apparatus, according to an example of the present disclosure;

FIGS. 2A and 2B, respectively, show flow diagrams of methods for estimating a metric related to a service demand, according to examples of the present disclosure;

FIGS. 3A-3E, respectively, depict hierarchies of services and services components, according to examples of the present disclosure;

FIGS. 4A-4C, respectively, depict services ecosystems, each composed of a matrix of elements, according to examples of the present disclosure; and

FIG. 5 illustrates a schematic representation of a computing device, which may be employed to perform various functions of the metric estimating apparatus depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Organizations, such as, information technology (IT) service providers, are increasingly interested in determining information about various metrics, such as, sustainability, power consumption, cost, etc., associated with various services, such as, IT services, etc., that they provide. In other words, organizations are interested in determining the kind of impact, which is recited herein as a “metric”, that providing of a service has on, for instance, the environment generally, energy consumption, resource consumption, carbon dioxide emissions, water use, recycling, operating cost, etc. Determining various metrics of a particular organization, such as, a cloud services provider, an internet mail (e-mail) service provider, a data center provider, etc., in providing various IT services, such as, cloud computing resources, e-mail service, computing resources, etc., has involved manually determining the services components the organization employs to provide the various services and determining the metrics related to each of the components. When information on the services components is available, the lower-level metrics, that is, those metrics related to each of the services components, may be used to determine a higher level metric associated with the services provided by the organization. Thus, for instance, if an organization is known to employ a certain number of services components of particular types, the lower-level metrics of those particular types of services components may be determined and a higher level metric, such as sustainability, may be determined simply by multiplying the number of services components with the lower-level metric values.

In many instances, however, information on the services components, such as, underlying services, virtual machines, physical machines, utilization, etc., employed by a particular organization to deliver a service is not available or is difficult to obtain. For instance, an organization may not publish or otherwise make public the services and the services components in a supply chain that the organization employs in delivering the service.

Disclosed herein are a method and an apparatus for estimating a metric related to a service demand without having detailed knowledge of the services components employed to provide the service demand. In the method and apparatus disclosed herein, a framework to be used in evaluating a services ecosystem is defined, in which the framework includes a matrix of elements that is to be used as a model in estimating the metric related to the service demand. According to an example, the matrix is defined with services and services components associated with a known service. Thus, for instance, the matrix is defined with the services and services components that are known to be used to provide a particular service, such as, a cloud-based service, and also includes the particular service. In addition, the matrix is also defined to include dependencies, if any, between the services and the services components. To estimate a metric related to a particular service demand that is not listed in the matrix, the particular service demand is mapped to the most representative (or most similar) service within the matrix. In addition, an n-tier metric impact of the most representative (or most similar) service within the matrix is estimated and the metric of the particular service demand is estimated to be substantially equivalent to the metric of the most representative service to which the particular service demand has been mapped.

Through implementation of the method and apparatus disclosed herein, a metric related to a service demand is estimated without having to model or otherwise determine the lower-level metrics associated with meeting the service demand. Particularly, the method and apparatus disclosed herein enable a metric related to a service demand to be estimated through an entire service supply-chain, that is, the end-to-end route a service takes through virtualized and physical IT infrastructure from a client, to the infrastructure components, and back to the client. As such, the method and apparatus disclosed herein enable the metric to be estimated in instances where information pertaining to the lower-level metrics associated with the service demand is unavailable or incomplete.

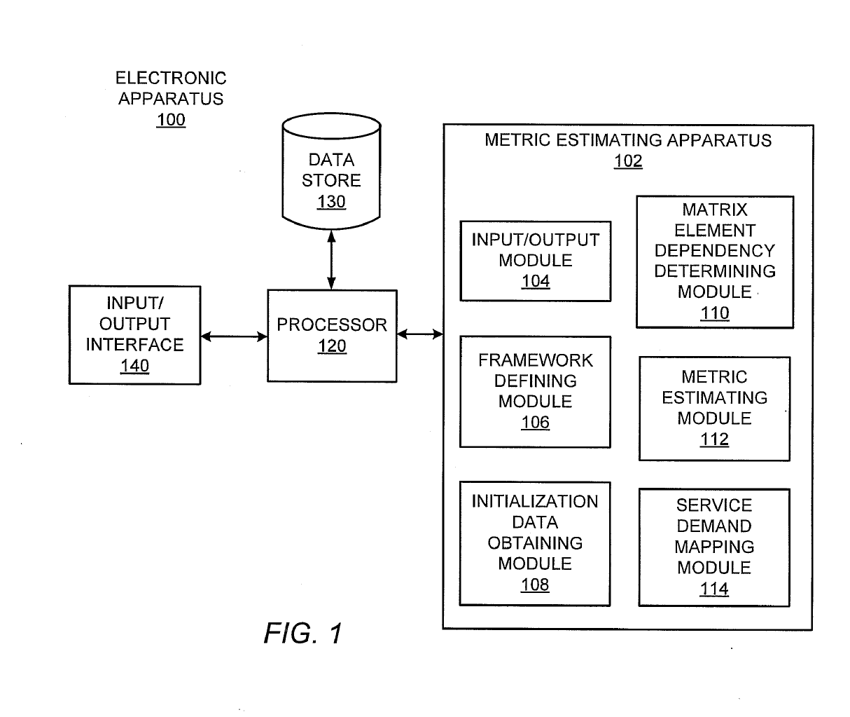

With reference first to FIG. 1, there is shown a block diagram of an electronic apparatus 100, according to an example. It should be understood that the electronic apparatus 100 may include additional components and that one or more of the components described herein may be removed and/or modified without departing from a scope of the electronic apparatus 100.

The electronic apparatus 100 includes a metric estimating apparatus 102, a processor 120, a data store 130, and an input/output interface 140. The electronic apparatus 100 comprises a server, a computer, a laptop computer, a tablet computer, a personal digital assistant, a cellular telephone, or other electronic apparatus that is to perform a method for estimating a metric related to a service demand disclosed herein.

The metric estimating apparatus 102 is depicted as including an input/output module 104, a framework defining module 106, an initialization data obtaining module 108, a matrix element dependency determining module 110, a metric estimating module 112, and a service demand mapping module 114. The processor 120, which may comprise a microprocessor, a micro-controller, an application specific integrated circuit (ASIC), and the like, is to perform various processing functions in the electronic apparatus 100. One of the processing functions includes invoking or implementing the modules 104-114 contained in the metric estimating apparatus 102 as discussed in greater detail herein below.

According to an example, the metric estimating apparatus 102 comprises a hardware device, such as, a circuit or multiple circuits arranged on a board. In this example, the modules 104-114 comprise circuit components or individual circuits. According to another example, the metric estimating apparatus 102 comprises a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 104-114 comprise software modules stored in the metric estimating apparatus 102. According to a further example, the modules 104-114 comprise a combination of hardware and software modules.

The input/output interface 140 may comprise a hardware and/or a software interface. In any regard, the input/output interface 140 may be connected to a network, such as, the Internet, an intranet, etc., over which the metric estimating apparatus 102 may receive data. The processor 120 may store data received through the input/output interface 140 in the data store 130 and may use the data in implementing the modules 104-114. The data store 130 comprises volatile and/or non-volatile memory, such as DRAM, EEPROM, MRAM, phase change RAM (PCRAM), Memristor, flash memory, and the like. In addition, or alternatively, the data store 130 comprises a device that is to read from and write to a removable media, such as, a floppy disk, a CD-ROM, a DVD-ROM, or other optical or magnetic media.

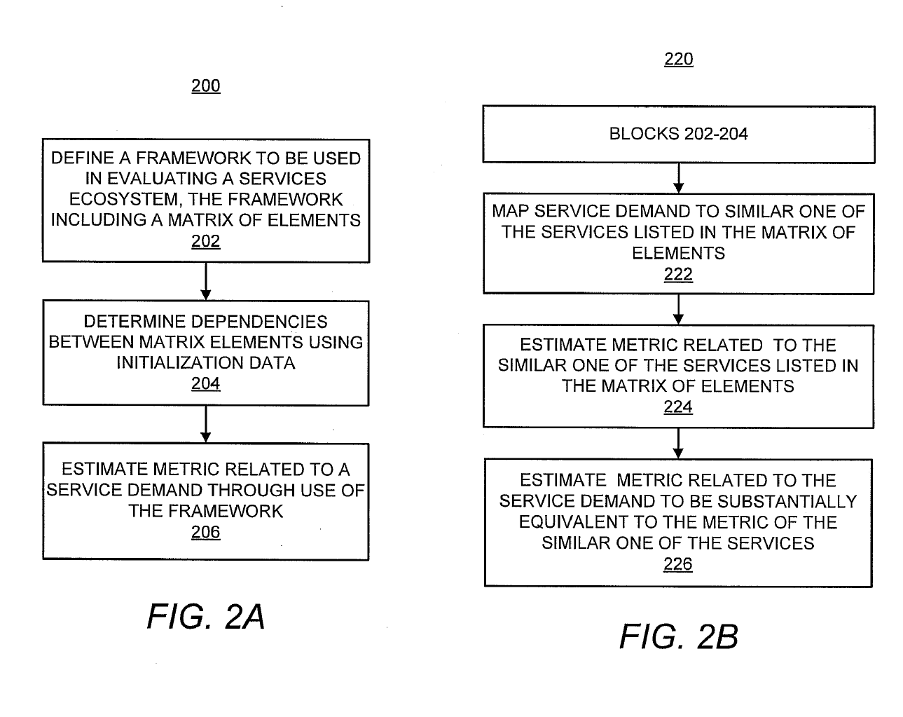

Various manners in which the modules 104-114 of the metric estimating apparatus 102 may be implemented are discussed in greater detail with respect to the method 200 depicted in FIG. 2A. FIG. 2A, more particularly, depicts a flow diagram of a method 200 for estimating a metric related to a service demand, according to an example. It should be apparent to those of ordinary skill in the art that the method 200 represents a generalized illustration and that other steps may be added or existing steps may be removed, modified or rearranged without departing from a scope of the method 200. Although particular reference is made to the metric estimating apparatus 102 depicted in FIG. 1 as comprising an apparatus and/or a set of machine readable instructions that may perform the operations described in the method 200, it should be understood that differently configured apparatuses and/or machine readable instructions may perform the method 200 without departing from a scope of the method 200.

Generally speaking, the method 200 may be implemented to estimate a metric related to a service demand, in which information pertaining to the services and the services components that are used to deliver the service demand are unknown or incomplete.

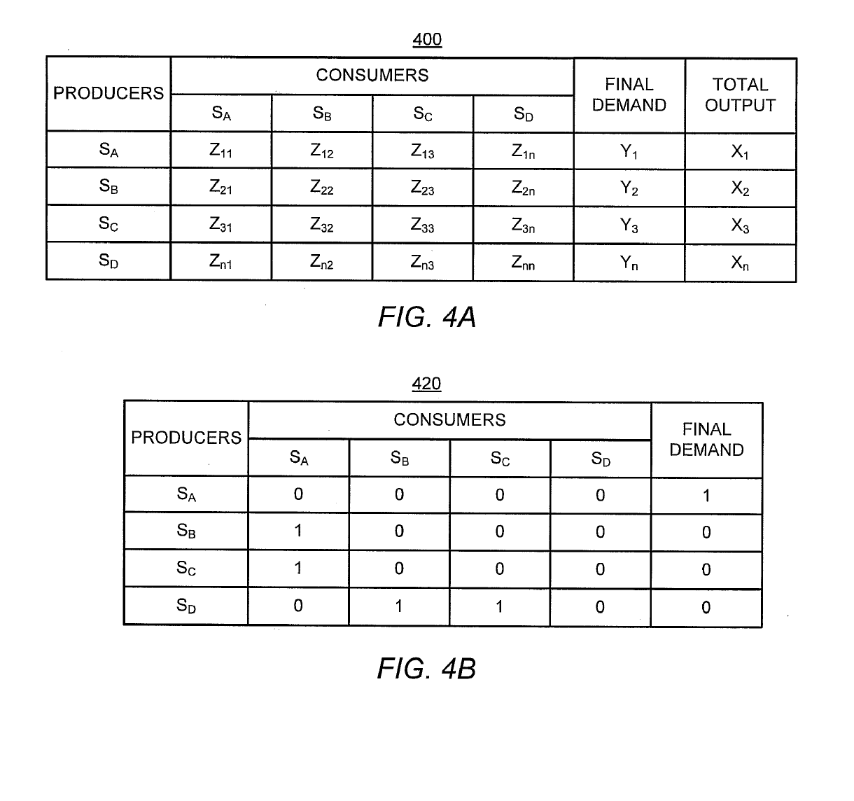

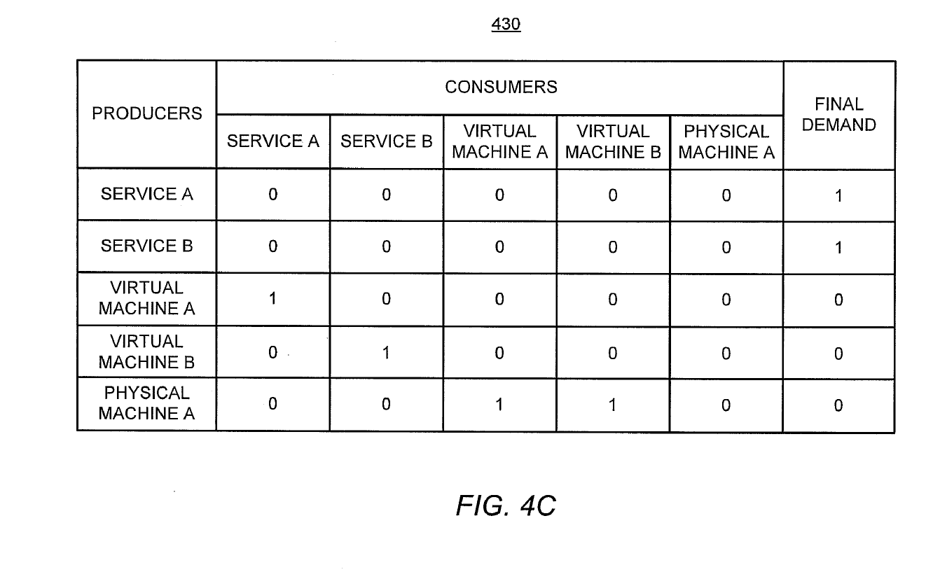

At block 202, a framework to be used in evaluating a services ecosystem or a services infrastructure is defined, for instance, by the framework defining module 106. The framework comprises a matrix of elements, in which the elements comprise a plurality of services and a plurality of services components that are usable in delivering at least one of the plurality of services. The framework may also include a final demand vector and a total output, for instance, as shown in FIG. 4A and discussed below. At block 204, dependencies between the matrix elements are determined using initialization data, for instance, by the matrix element dependency determining module 110. At block 206, the metric related to the service demand is estimated through use of the framework, for instance, by the metric estimating module 112. Each of the operations performed in the method 200 will be described in greater detail with respect to the following figures.

The services and the services components contained in the matrix of elements defined at block 202 generally comprise various services and services components related to a service delivery. By way of particular example, the matrix of elements defined at block 202 comprises the services and services components that an organization uses to deliver an IT service, such as, cloud computing, e-mail messaging, etc. In this example, the services contained in the matrix of elements may comprise an end service, such as, a cloud computing service, for which a user makes a demand. The services may also comprise other services that are performed to provide the end service. In addition, the services components may comprise virtual machines and physical machines that are used to provide the services. Generally speaking, therefore, and according to an example, the services and the services components correspond/relate to a service architecture and infrastructure of an IT service.

According to an example, the determination of which services and services components to include in the matrix of elements, such as, the service architecture and infrastructure of an IT service, may be based upon information gathered from various information sources. For instance, the information may be gathered from publicly available sources, such as, the Internet. As another example, the information may be obtained from privately accessible sources, such as, a secure server, or from the organizations that provide the services. In any regard, the input/output module 104 may operate to obtain or receive the information through the input/output interface 140 and may store the information in the data store 130.

In addition, or alternatively, the services and the services components included in the matrix of elements defined at block 202 comprise those services and services components for which lower-level metric data is available for a particular service. In instances where the lower-level metric data is unavailable for the services and services components, various modeling and/or techniques may be employed to determine the lower-level metric data. Various methods for determining the lower-level metric data may be found in co-pending PCT Application Serial Nos. PCT/US2011/56490 and PCT/US2011/56491.

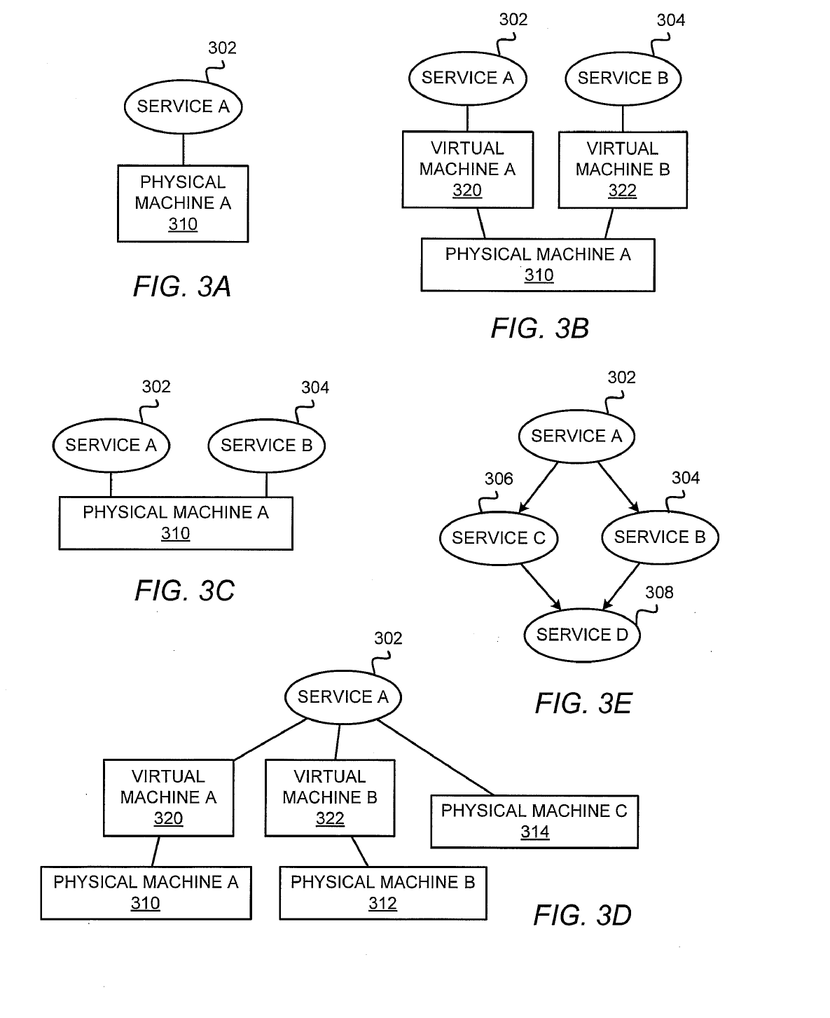

According to an example, to identify the elements to be included in the matrix of elements, a hierarchy of the services and the services components that are used to deliver a particular service may be identified. The hierarchy of the services and the services components may also be based upon information gathered from various information sources. Various examples of services and services components are shown in FIGS. 3A-3E. With reference first to FIG. 3A, a service A 302 is depicted as using a physical machine A 310, which may comprise a physical server. In FIG. 3B, the service A 302 is depicted as using a virtual machine A 320, which in turn uses physical machine A 310. In addition, a service B 304 is depicted as using a virtual machine B 322, which in turn also uses physical machine A 310. In FIG. 3C, both service A 302 and service B 304 are depicted as using the same physical machine 310. In FIG. 3D, the service A 302 is depicted as using a first virtual machine 320, which in turn uses physical machine A 310, and a second virtual machine 322, which in turn uses physical machine B 312. The service A 302 is also depicted as using a third physical machine C 314. In FIG. 3E, service A 302 is depicted as using services B and C 304, 306, which then use service D 308. According to an example, service D 308 comprises an infrastructure service providing IT resource, for instance, computer, network, and storage equipment.

Turning now to FIG. 4A, there is shown a services ecosystem composed of a matrix of elements 400 corresponding to the hierarchy of services depicted in FIG. 3E, according to an example. As shown therein, the matrix of elements includes service A (S_{A}) 302, service B (S_{B}) 304, service C (S_{C}) 306, and service D (S_{D}) 308. The matrix of elements is also depicted as comprising a plurality of rows, which correspond to producers of service resources, such as, physical machines, virtual machines, or services. In addition, the matrix of elements is depicted as comprising a plurality of columns, which correspond to consumers of the service resources, which may also include physical machines, virtual machines, or services. In the matrix of elements 400 shown in FIG. 4A, therefore, if service A 302 is a consumer of service B 304, then the inter-component relationship between service A 302 and service B will have a value other than zero.

According to an example, each of the producers and the consumers corresponds to respective individual services, if the appropriate lower-level data are available. However, if the appropriate lower-level data are not available, the producers and the consumers may instead be listed as similar representative services or classes of services.

As noted above with respect to FIG. 2, at block 204, dependencies between the matrix elements, which according to an example, corresponds to the services and services components for IT services, are determined using initialization data. In other words, the matrix disclosed herein is set up to correspond to/reflect the service architecture and infrastructure of an IT service. The initialization data may comprise the hierarchy of services and services components that are used to deliver a particular service, for instance, in the examples depicted in FIGS. 3A-3E. The dependencies between the matrix elements are defined as matrix coefficients (zᵢⱼ) in the matrix of elements 400, which describe inter-component relationships between the elements contained in the rows and the elements contained in the columns of the matrix of elements 400. Generally speaking, the matrix coefficients (zᵢⱼ) describe dependencies between the elements, which may include services and/or services components, with respect to each other. The initialization data used to determine the dependencies comprises, for instance, the hierarchy of the services and the services components that are used to deliver a particular service, such as those depicted in FIGS. 3A-3E.

By way of example, and with respect to the diagram depicted in FIG. 3E, consider a scenario in which a service demand is made for one unit of service A 302. In this example, a unit of demand may be, for instance, a request for a particular service. As shown in FIG. 3E, each unit of service A 302 requires one unit of service B 304 and one unit of service C 305, as denoted by the arrows directed from service A 302 to service B 304 and service C 306. In addition, each unit of service B 304 and service C 306 requires one unit of service D 308. Put differently, each of two units of service D 308, which is produced, will be consumed by service B 304 and service C 306, one unit of service C 306 would be consumed by service A 302, and one unit of service B 304 would also be consumed by service A 302. It should, however, be understood that if, for instance, 2 units of service B 304 are consumed by service A 302, the matrix coefficients would be 2 instead of one. In addition, the matrix coefficients may be normalized to particular units of each of the matrix elements. Moreover, one unit of final demand (y₁) is made for service A 302. A summary form of the matrix of elements 420 is depicted in FIG. 4B.

As shown in FIG. 4B, the matrix coefficient (z₂₁) for a service produced by service B 304 and consumed by service A 302 is listed as a “1”, the matrix coefficient (z₃₁) for a service produced by service C 306 and consumed by service A 302 is listed as a “1”, the matrix coefficient (zₙ₂) for a service produced by service D 308 and consumed by service B 304 is listed as a “1”, the matrix coefficient (zₙ₃) for a service produced by service D 308 and consumed by service C 306 is listed as a “1”, and the remaining matrix coefficients are listed as “0's”. The matrix of elements 420 therefore denotes that service A 302 is dependent upon services B and C 304, 306 and that services B and C 304, 306 are dependent upon service D 308, as depicted in FIG. 3E. In addition, the matrix of elements 420 indicates that one unit of demand for service A 304 is made.

Turning now to FIG. 4C, there is shown an example of a matrix of elements 430 for the services ecosystem corresponding to the hierarchy of elements depicted in FIG. 3B. As shown in FIG. 3B, a final demand for both service A 302 and service B 304 are made. As such, the final demands for both of these services are listed as “1's”. In addition, service A 302 is depicted as consuming a service provided by virtual machine A 320, which in turn consumes a service provided by physical machine A 310. In addition, service B 304 is depicted as consuming a service provided by virtual machine B 322, which in turn also consumes a service provided by physical machine A 310. As such, the matrix coefficient for service A 302 and virtual machine A 320 is listed as a “1”, the matrix coefficient for service B 304 and virtual machine B 322 is listed as a “1”, the matrix coefficient for virtual machine A 320 and physical machine A 310 is listed as a “1”, the matrix coefficient for virtual machine B 322 and physical machine A 310 is listed as a “1”, and the remaining matrix coefficients are listed as “0's”.

With reference back to FIG. 4A, given the matrix of elements 400, including a final demand vector (Y=y₁, . . . , yₙ), the total production of a service may be represented by a total output vector (X). The final demand vector is a summary of the demand, for instance, by end users, for the various services in the services ecosystem. The total output vector (X) may be determined from the following equation:

x₁=z₁₁+z₁₂+z₁₃+ . . . +z₁ₙ+y₁ Equation (1):

For calculation purposes, Equation (1) may be generalized by assuming that the flows between services are represented as a percentage of service output. This flow is represented by dividing the flow from service i to service j by the total output of service j. Thus, the inter-service flow may be represented as follows:

$${a}_{ij} = \frac{{z}_{ij}}{{x}_{j}} ,$$

where aᵢⱼ is a unitless technical coefficient that ranges in value from 0 to 1. As such, Equation (1) may be rewritten as:

x₁=aᵢ₁x₁+aᵢ₂xᵢ₂+ . . . +aᵢₙxₙ+y₁ Equation (2):

Let the matrix A contain all of the technical coefficients (aᵢⱼ terms), vector X all the output (xᵢ) terms, and vector Y terms, then:

X−AX=[I−A]X=Y, or X=[I−A]⁻¹Y Equation (3):

A decomposition of the general n×n form of [I−A]⁻¹ gives:

X=Y+AY+A²Y+A³Y+ . . . +AⁿY Equation (4):

Equation (4) provides a method of evaluating, for a given demand of a single service, how much dependent resources (across the entire services supply chain) are required. In this regard, Equation (4) may be implemented to estimate the metric related to the service demand based upon the determined dependencies in the matrix of elements, as noted above with respect to FIG. 2, at block 206. For instance, in the first round (AY), an identification of how many of the other services (B, C, D) or services components (virtual machine A, virtual machine B, physical machine A), may be required to satisfy demand for a service A. However, each of these services (B, C, D) in turn may require some fraction of services or resources to be instantiated. This is captured in the second round (A²Y). The full power series approximation in Equation (4) thus provides a relatively simple method by which the total amount of services and/or services components across an n-tier supply chain are required to satisfy a final demand.

Once the output for each service (x) has been determined, a vector of a metric, such as, direct environmental outputs, related to each service may then be obtained by multiplying the output at each stage by the metric per service unit according to the following equation:

bₙ=RₙX, or bₙ=Rₙ(I−A)⁻¹Y Equation (5):

In Equation (5), bₙ is a vector of a metric, such as, environmental impact (for instance, toxic emissions, electricity use, water use, etc.), price, cost, etc., for each service unit, Rₙ is a matrix with diagonal elements representing the impact per service unit of output at each stage, and the subscript n represents a particular type of metric (for instance, environmental impact (electricity, toxic emissions, etc.), price, cost, etc. Various examples of manners in which the impact per service unit may be evaluated for a sample or representative set of services is described in PCT Application Serial No. PCT/US2011/56490.

According to an example, the service demand for which a metric is to be estimated is contained in the framework defined at block 202. In this example, at block 204, the metric related to the service demand is determined through a determination of a solution to Equation (5).

According to another example, the service demand for which a metric is to be estimated is not contained in the framework defined at block 202. This example is depicted in FIG. 2B, which shows a flow diagram of a method 220 for estimating a metric related to a service demand, according to an example. As shown in FIG. 2B, after blocks 202 and 204, at block 222, the service demand for which the metric is to be estimated is mapped to a similar one of the services listed in the matrix of elements, for instance, by the service demand mapping module 114. Particularly, the service demand is mapped to the service that is the most similar to the service demand. By way of example, if the service demand is for cloud computing services provided by a first organization, the service demand may be mapped to a cloud computing service for another organization listed in the framework.

In addition, at block 224, a metric related to the similar one of the plurality of services listed in the matrix of elements is estimated, for instance, by the metric estimating module 112. The metric related to the similar one of the plurality of services listed in the matrix of elements may be estimated in the manners discussed above.

At block 226, the metric related to the service demand is estimated to be substantially equivalent to the metric related to the similar one of the plurality of services listed in the matrix of elements estimated at block 224. By way of example, the metric related to the service demand is estimated to be within about 10% or less of the metric estimated at block 224.

In some instances, the service demand is incompatible with the dependencies contained in the matrix of elements. In these instances, the service demand may be normalized to be compatible with the dependencies contained in the matrix of elements. In this regard, for instance, the units of the service demand may be normalized such that the units are compatible with the units employed in the matrix of elements. By way of example in which a service demand y is modeled in terms of number of CPU cycles, the coefficients of a matrix A may be per unit time, while the environmental impacts R may be per unit dollar. In this example, the CPU cycles may be normalized by converting the number of CPU cycles to CPU cycles per unit time (to get A and y to reconcile) and CPU cycles per unit dollar (to get the total output vector X and R to reconcile.

In any regard, following either of FIGS. 2A and 2B, the estimated metric related to the service demand may be stored in the data store 130 and/or outputted, for instance, by the input/output module 104.

Some or all of the operations set forth in the methods 200 and 220 may be contained as a utility, program, or subprogram, in any desired computer accessible medium. In addition, the methods 200 and 220 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

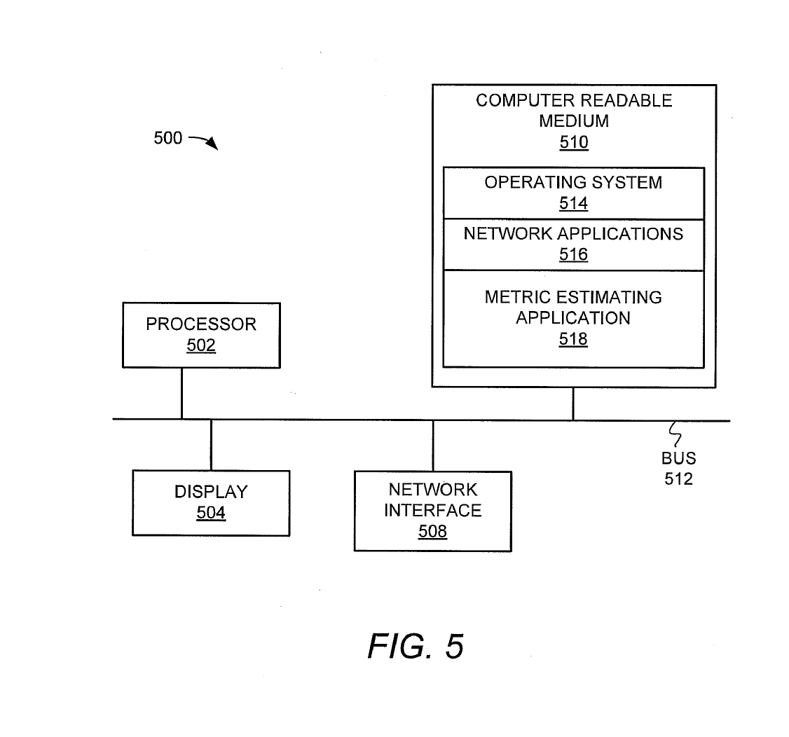

Turning now to FIG. 5, there is shown a schematic representation of a computing device 500, which may be employed to perform various functions of the metric estimating apparatus 102 depicted in FIG. 1, according to an example. The computing device 500 includes a processor 502, such as but not limited to a central processing unit; a display device 504, such as but not limited to a monitor; a network interface 508, such as but not limited to a Local Area Network LAN, a wireless 802.11x LAN, a 3G mobile WAN or a WiMax WAN; and a computer-readable medium 510. Each of these components is operatively coupled to a bus 512. For example, the bus 512 may be an EISA, a PCI, a USB, a FireWire, a NuBus, or a PDS.

The computer readable medium 510 comprises any suitable medium that participates in providing instructions to the processor 502 for execution. For example, the computer readable medium 510 may be non-volatile media, such as memory. The computer-readable medium 510 may also store an operating system 514, such as but not limited to Mac OS, MS Windows, Unix, or Linux; network applications 516; and a metric estimating application 518. The operating system 514 may be multi-user, multiprocessing, multitasking, multithreading, real-time and the like. The operating system 514 may also perform basic tasks such as but not limited to recognizing input from input devices, such as but not limited to a keyboard or a keypad; sending output to the display 504; keeping track of files and directories on medium 510; controlling peripheral devices, such as but not limited to disk drives, printers, image capture device; and managing traffic on the bus 512. The network applications 516 include various components for establishing and maintaining network connections, such as but not limited to machine readable instructions for implementing communication protocols including TCP/IP, HTTP, Ethernet, USB, and FireWire.

The metric estimating application 518 provides various components for estimating a metric related to a service demand as discussed above with respect to the methods 200 and 220 in FIGS. 2A and 2B. The metric estimating application 518 may thus comprise the input/output module 104, the framework defining module 106, the initialization data obtaining module 108, the matrix element dependency determining module 110, the metric estimating module 112, and the service demand mapping module 114. In this regard, the metric estimating application 518 may include modules for defining a framework to be used in evaluating a services ecosystem, said framework comprising a matrix of elements, wherein the elements comprise a plurality of services and a plurality of services components that are usable in delivering at least one of the plurality of services, determining dependencies between the matrix elements using initialization data, and estimating the metric related to the service demand through use of the framework.

In certain examples, some or all of the processes performed by the application 518 may be integrated into the operating system 514. In certain examples, the processes may be at least partially implemented in digital electronic circuitry, or in computer hardware, machine readable instructions (including firmware and software), or in any combination thereof, as also discussed above.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for estimating a metric related to a service demand, said method comprising:
defining a framework to be used in evaluating a services ecosystem or a services infrastructure, said framework comprising a matrix of elements, wherein the elements comprise a plurality of services and a plurality of services components that are usable in delivering at least one of the plurality of services;
determining dependencies between the matrix elements using initialization data; and
estimating, by a processor, the metric related to the service demand through use of the framework.

2. The method according to claim 1, further comprising:
obtaining the initialization data from at least one of publicly available information and modeling of the services and the services components.

3. The method according to claim 1, wherein the matrix comprises rows and columns, and wherein defining the framework further comprises generating the matrix to include producers of the plurality of services and the plurality of services components in the rows and consumers of the plurality of services and the plurality of services components in the columns.

4. The method according to claim 1, further comprising:
populating the matrix of elements with coefficients that indicate the determined dependencies between the matrix elements.

5. The method according to claim 1, wherein the matrix elements comprise at least one of individual services and classes of services.

6. The method according to claim 1, wherein defining the framework further comprises:
generating the matrix to define mappings of the plurality of services and the plurality of services components with respect to each other.

7. The method according to claim 1, wherein defining the framework further comprises:
generating the matrix to correspond to a service architecture and infrastructure of an information technology (IT) service, wherein the plurality of services and the plurality of services components correspond to the service architecture and the infrastructure of the IT service.

8. The method according to claim 1, wherein the service demand is not listed in the matrix of elements, said method further comprising:
mapping the service demand to a similar one of the plurality of services;
estimating a metric related to the similar one of the plurality of services listed in the matrix of elements a metric; and
wherein estimating the metric related to the service demand further comprises estimating the metric related to the service demand to be substantially equivalent to the metric related to the similar one of the plurality of services listed in the matrix of elements.

9. The method according to claim 8, further comprising:
normalizing the service demand to be compatible with the matrix of elements prior to mapping the service demand to the similar one of the plurality of services listed in the matrix of elements.

10. An electronic apparatus for estimating a metric related to a service demand, said electronic apparatus comprising:
at least one module to,
define a framework to be used in evaluating a services ecosystem or a services infrastructure, said framework comprising a matrix of elements, wherein the elements comprise a plurality of services and a plurality of services components that are useable in delivering at least one of the plurality of services, wherein the matrix comprises rows and columns, and wherein producers of the plurality of services and the plurality of services components are included in the rows and consumers of the plurality of services and the plurality of services components are included in the columns;
determine dependencies between the matrix elements using initialization data;
populate the matrix of elements with coefficients that indicate the determined dependencies between the matrix elements; and
estimate the metric related to the service demand through use of the framework; and
a processor to implement the at least one module.

11. The apparatus according to claim 10, wherein the at least one module is further to:
generate the matrix to define mappings of the plurality of services and the plurality of services components with respect to each other.

12. The apparatus according to claim 10, wherein the at least one module is further to:
generate the matrix to correspond to a service architecture and infrastructure of an information technology (IT) service, wherein the plurality of services and the plurality of services components correspond to the service architecture and the infrastructure of the IT service.

13. The apparatus according to claim 11, wherein the service demand is not listed in the matrix of elements, and wherein the at least one module is further to:
map the service demand to a similar one of the plurality of services;
estimate a metric related to the similar one of the plurality of services listed in the matrix of elements a metric; and
estimate the metric related to the service demand to be substantially equivalent to the metric for the similar one of the plurality of services.

14. A non-transitory computer readable storage medium on which is stored machine readable instructions that when executed by a processor, implement a method for estimating a metric related to a service demand, said machine readable instructions comprising code to:
define a framework to be used in evaluating a services ecosystem or a services infrastructure, said framework comprising a matrix of elements, wherein the elements comprise a plurality of services and a plurality of services components that are usable in delivering at least one of the plurality of services;
determining dependencies between the matrix elements using initialization data;
map the service demand to a similar one of the plurality of services listed in the matrix of elements;
estimate a metric related to the similar one of the plurality of services listed in the matrix of elements; and
estimate the metric related to the service demand to be substantially equivalent to the metric related to the similar one of the plurality of services listed in the matrix of elements.

15. The non-transitory computer readable storage medium according to claim 14, wherein the set of machine readable instructions further comprises code to:
define the matrix to correspond to a service architecture and infrastructure of an information technology (IT) service, wherein the plurality of services and the plurality of services components correspond to the service architecture and the infrastructure of the IT service.
